(19) United States
(12) Patent Application Publication
(10) Pub. No.: US 2008/0288675 A1
(43) Pub. Date: Nov. 20, 2008

(54) HOST DEVICE, INFORMATION PROCESSOR, ELECTRONIC APPARATUS, PROGRAM, AND METHOD FOR CONTROLLING READING

(75) Inventor: Shinsuke KUBOTA, Sapporo (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/122,210

(22) Filed: May 16, 2008

(30) Foreign Application Priority Data
May 18, 2007 (JP) 2007-133230

(51) Int. Cl. G06F 13/00

(52) U.S. Cl. 710/56

(57) ABSTRACT

A host device for controlling a storage device controller to access a storage device includes: a command issue controller controlling an issue of a command for allowing the storage device controller to access the storage device; a response detector for detecting a reception of a response from the storage device corresponding to the command; and a buffer data controller controlling reading and writing of a buffer of the storage device controller. The buffer stores one of reading data and writing data of the storage device. The buffer data controller controls one of the reading and the writing at least once in a predetermined data size unit corresponding to the command after the command issue controller issues the command.

The entire disclosure of Japanese Patent Application No. 2007-133230, filed May 18, 2007 is expressly incorporated by reference herein.

### BACKGROUND

1. Technical Field

The present invention relates to a host device, an information processor, an electronic apparatus, a program, and a method for controlling reading.

2. Related Art

In recent years, a flash memory card is frequently used for a data storage purpose for not only personal computers and peripheral devices of the personal computers (e.g. printers, scanners, or multifunctional printers), but also portable information technology devices such as cellular phones, personal digital assistants (PDAs), and audio players; and electronic apparatuses such as robotics devices, digital cameras, video cameras, global positioning system (GPS) devices, TV receivers, and projectors.

Such flash memory cards are regulated in various standards and versions as usage. Examples of a high-capacity flash memory that is superior in portability for portable use of video data, still image data, or music data include flash memory cards complying with the MultiMedia Card (MMC) standard, the Secure Digital (SD) standard, and I/O devices complying with the SD Input/Output (SDIO) standard. Further, an example of an HDD device having a connector in a smaller shape and achieving high-speed data transfer along with downsizing of mobile devices and consumer electronics includes a storage device complying with the consumer electronics-at attachment (CE-ATA) standard.

As the above, usage of portable data storage is likely to expand more and more from now on, and an optimum standard for intended purposes tends to be sequentially formulated.

The flash memory card or the like as the above is coupled to a card controller via a cardbus in a specification that is regulated in such standard, and accessed when the card controller issues a command (control command) regulated by the standard.

A technique for issuing a command to access a flash memory card is disclosed in JP-A-2002-342256, for example. JP-A-2002-342256 discloses a data processor that facilitates adding and changing a command to be used.

In the technique disclosed in JP-A-2002-342256, an interface action of a data processor is defined by separating into a first control information and a second control information corresponding to the first control information. The first control information controls an operation of a device requiring interface control, while the second control information controls an interface operation with the device requiring the interface control. Therefore, in the technique disclosed in JP-A-2002-342256, the first and second control information is correctable when a command, a function, and an operation for accessing to the device requiring interface control need to be added or changed.

However, the MMC standard and the SD standard have various types of commands corresponding to presence of a response and control of transfer data, and a control direction (writing, and data reading) of the transfer data when the transfer data is controlled, or the like. Therefore, commonly, a host device controlling a card controller needs to have a function (circuit issuing a command in a case of hardware processing) by a type of commands in software processing, and thus a code quantity of the functions issuing commands is required to be reduced. Accordingly, by making command-issuing function (issue circuit) widely used, even when command types increase in number, a code quantity (hardware volume) is preferably prevented from increasing.

Further, the cardbus includes a clock line in which a transfer clock is transferred as a transfer sync clock, a command line in which a command and its response are transferred, and a data line in which a transfer data is transferred. When data transfer needs to be interrupted due to various issues, by disrupting the transfer clock, the command, the response, or the transfer data is interrupted. However, depending on a method for controlling transfer data in a host device controlling a card controller, data transfer from/to a flash memory card or the like needs to be interrupted (especially at reading transfer) in order to prevent the transfer data from overflowing or the like. Such interruption of data transfer makes an accessing time of a flash memory card long, and further causes incompletion of the transfer without sending back a response. In addition, in order to reduce the accessing time, buffer in a card controller or a host device needs to have high capacity.

### SUMMARY

An advantage of the invention is to provide a host device, an information processor, an electronic apparatus, a program, and a method for controlling reading that can suppress increase of a code quantity and a hardware volume even when command types increase in number.

Another advantage of the invention is to provide a host device, an information processor, an electronic apparatus, a program, and a method for controlling reading that can achieve a reading action from a storage device without interrupting data transfer even when a buffer has small capacity.

A host device for controlling a storage device controller to access a storage device according to a first aspect of the invention includes a command issue controller controlling an issue of a command for allowing the storage device controller to access the storage device, a response detector for detecting a reception of a response from the storage device corresponding to the command, and a buffer data controller controlling reading and writing of a buffer of the storage device controller. The buffer stores one of reading data and writing data of the storage device. The buffer data controller controls one of the reading and the writing at least once in a predetermined data size unit corresponding to the command after the command issue controller issues the command.

In the first aspect of the invention, corresponding to a type of the command issued by the command issue controller, even in a case where control sequences such as presence of reception of the response, presence of output of the writing data, and presence of inputs of the reading data vary, control that is required can be simply operated corresponding to the command since the command issue control, the response receiving control (detecting reception), and the input-output data of the FIFO data are separated. Therefore, according to the first aspect, by each command, the command issue controller, the response detector, and the FIFO data controller can be commonly used.

In this case, the buffer data controller may store the data being read from the buffer in a given memory, obtain a size of the data to be stored in the memory during a period from an issue of the command to a completion of receiving the response for the storage device controller from the storage device as a pre-read size corresponding to the command, and store the data being read from the buffer in order starting from a storage region of the memory that is shifted for the pre-read size after the response is completely received.

The data can be thus read from the buffer until the reception of the response is completed, and further the buffer is prevented from being full. Therefore, without stopping a transfer clock due to the buffer being full, the data is continuously read from the buffer after the reception of the response is completed, reducing a transfer time for the reading action. Further, capacity of the buffer can be reduced, contributing cost reduction of the storage device controller.

In this case, if the storage device controller outputs a transfer clock as a transfer synchronous clock to the storage device, and stops outputting the transfer clock when the buffer is full, the buffer data controller may read the data from the buffer that is full and update the pre-read size by adding a size of the data.

In this case, the buffer data controller may read the data from the buffer and update the pre-read size if the buffer is full, and a size of the data to be read from the storage device specified by the command is more than or equal to a data size that is storable in the buffer.

In this case, the buffer data controller may read data from the buffer in a data size unit that is a storable in the buffer.

According to the above, for example, in addition to simplifying reading control for the buffer, that is, the pre-read size control, and unnecessary reading control can be avoided.

An information processor according to a second aspect of the invention includes the storage device controller including the buffer buffering data from the storage device, and the host device according to the aspect in the above controlling an issue of the command to the storage device controller.

This can provide the information processor employing the host device that can suppress increase of a code quantity and a hardware volume even when command types increase in number. Alternatively, this can provide the information processor employing the host device that can achieve a reading action from the storage device without interrupting data transfer even when the buffer of the storage device controller has small capacity.

An electronic apparatus according to a third aspect of the invention includes a storage device inserted portion from which the storage device is inserted and ejected, and the information processor described above.

This can provide the electronic apparatus employing the host device that can suppress increase of a code quantity and a hardware volume even when command types increase in number. Alternatively, this can provide the electronic apparatus employing the host device that can achieve a reading action from the storage device without interrupting data transfer even when the buffer of the storage device controller has small capacity.

A program for controlling a storage device controller to access a storage device according to a fourth aspect of the invention includes an operating command for instructing a computer to serve as: a command issue controller to control an issue of a command for allowing the storage device controller to access the storage device; a response detector to detect a reception of a response from the storage device corresponding to the command; and a buffer data controller to control reading and writing of a buffer of the storage device controller. The buffer stores one of reading data and writing data of the storage device. The buffer data controller controls one of the reading and the writing at least once in a predetermined data size unit corresponding to the command after the command issue controller issues the command.

This can provide the program controlling the storage device controller for accessing the storage device and suppressing increase of a code quantity and a hardware volume even when command types increase in number.

In this case, the buffer data controller may store the data being read from the buffer in a given memory, obtain a size of the data to be stored in the memory during a period from an issue of the command to a completion of receiving the response for the storage device controller from the storage device as a pre-read size corresponding to the command and may store the data being read from the buffer in order starting from a storage region of the memory that is shifted for the pre-read size after the response is completely received.

In this case, if the storage device controller outputs a transfer clock as a transfer synchronous clock to the storage device, and stops outputting the transfer clock when the buffer is full, the buffer data controller may read the data from the buffer that is full and update the pre-read size by adding a size of the data.

In this case, the buffer data controller may read the data from the buffer and update the pre-read size if the buffer is full, and a size of the data to be read from the storage device specified by the command is more than or equal to a data size that is storable in the buffer.

In this case, the buffer data controller may read data from the buffer in a data size unit that is a storable in the buffer.

According to the aspects of the invention above, the program that can achieve a reading action from the storage device without interrupting data transfer even when the buffer of the storage device controller has small capacity can be provided.

A method for controlling reading for a storage device controller buffering reading data from a storage device according to a fifth aspect of the invention includes: a) controlling an issue of a command for allowing the storage device controller to access the storage device; b) detecting a reception of a response from the storage device corresponding to the command; and c) controlling reading and writing of a buffer of the storage device controller. The buffer stores one of reading data and writing data of the storage device. The step c) includes controlling one of the reading and the writing at least once in a predetermined data size unit corresponding to the command after the command issue controller issues the command.

This can provide the method for controlling reading for accessing the storage device and suppressing increase of a code quantity and a hardware volume even when command types increase in number.

In this case, the step c) may further include: storing the data being read from the buffer in a given memory; obtaining a size of the data to be stored in the memory as a pre-read size during a period from an issue of the command to a completion of receiving the response for the storage device controller from the storage device corresponding to the command; and storing the data being read from the buffer in order starting from a storage region of the memory that is shifted for the pre-read size after the response is completely received.

In this case, if the storage device controller outputs a transfer clock as a transfer synchronous clock to the storage device, and stops outputting the transfer clock when the buffer is full, the step c) may include reading the data from the buffer that is full and updating the pre-read size by adding a size of the data.

In this case, the step c) may include reading the data from the buffer and updating the pre-read size if the buffer is full, and a size of the data to be read from the storage device specified by the command is more than or equal to a data size that is storable in the buffer.

In this case, the step c) may include reading data from the buffer in a data size unit that is a storable in the buffer.

According to the aspects of the invention above, the method for controlling reading that can achieve a reading action from the storage device without interrupting data transfer even when the buffer of the storage device controller has small capacity can be provided.

### BRIEF DESCRIPTION OF THE DRAWINGS

The invention will be described with reference to the accompanying drawings, wherein like numbers reference like elements.

FIG. 1 is a block diagram illustrating an example structure of an electronic apparatus employing a host device according to an embodiment.

FIG. 2A is a diagram describing a control command.

FIG. 2B is a diagram describing a response.

FIG. 3 is a block diagram showing an example structure of the card controller shown in FIG. 1.

FIG. 4 is a diagram schematically showing a structure of the controller control register in FIG. 3.

FIG. 5 is a diagram schematically showing a structure of the driver in FIG. 3.

FIG. 6 is a block diagram showing an example structure of the memory card in FIG. 1.

FIG. 7 is a diagram schematically showing a structure of the host device according to the embodiment.

FIG. 8 is a diagram describing a cardbus specification in the MMC standard or the like.

FIG. 9 is a diagram schematically showing a structure of a command table according to the embodiment.

FIG. 10 is a diagram showing an example of command setting information registered in each block of the command table in FIG. 9.

FIG. 11 is a flowchart illustrating an operation example of the host device shown in FIG. 7.

FIG. 12 is a flowchart illustrating an operation example of Step S11 shown in FIG. 11.

FIG. 13 is a diagram describing an advantageous effect according to the embodiment.

FIG. 14 is a diagram describing an address of a memory.

FIG. 15 is a block diagram showing an example structure of a digital still camera as an electronic apparatus according to the embodiment.

### DESCRIPTION OF EXEMPLARY EMBODIMENTS

An embodiment of the invention will now be described with reference to the accompanying drawings. The embodiment described below is not intended to unreasonably limit the invention set forth in the claims. Also, it should be understood that not all of the elements described below are required to put the invention into practice.

1. Information Processor

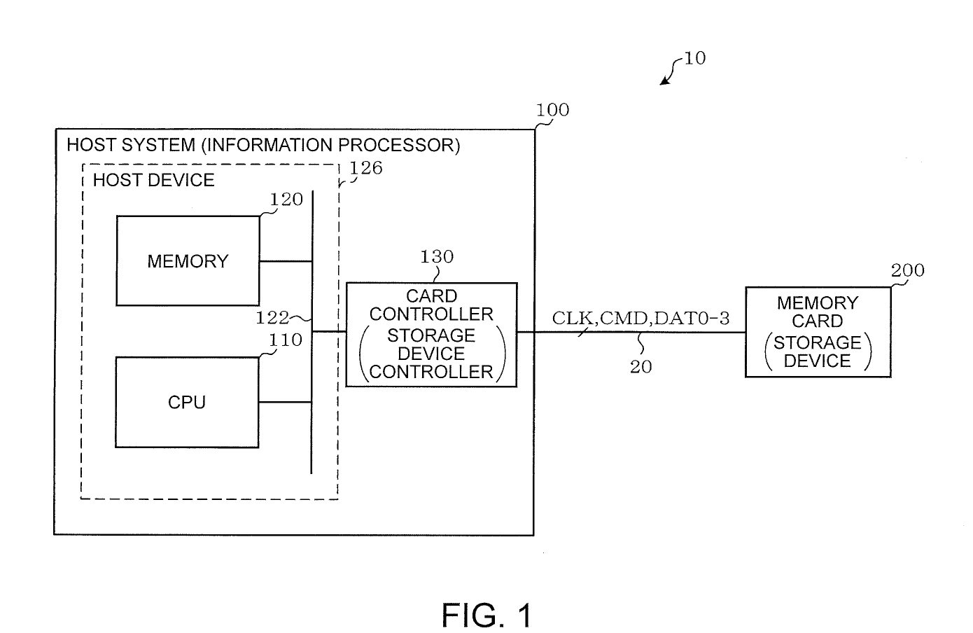

FIG. 1 shows a block diagram illustrating an example structure of an electronic apparatus employing a host device according to an embodiment.

Examples of the electronic device having a structure shown in FIG. 1 includes personal computers, peripheral devices of the personal computers (e.g. printers, scanners, or multifunctional printers), cellular phones, PDAs, audio players, robotics devices, digital cameras, video cameras, GPS devices, TV receivers, and projectors.

An electronic apparatus 10 includes a host system 100 serving as an information processor, and a memory card (storage device or storage system in a broad sense) 200. The host system 100 and the memory card 200 are coupled to each other through a cardbus 20. By an issue of a control command to the memory card 200, the electronic apparatus 10 can write data in the memory card 200, or read data from the memory card 200. The memory card 200 may be a flash memory card, I/O device, or an HDD apparatus, for example.

The host system 100 includes a host device 126, and a card controller (storage device controller, memory controller) 130. The host device 126 includes a central processing unit (CPU) 110 and a memory 120. The CPU 110, the memory 120, and the card controller 130 are coupled to each other through a systembus 122. Therefore, the CPU 110 can access the memory 120, and the card controller 130 through the systembus 122. Further, the CPU11O reads a program stored in the memory 120 so as to execute a process corresponding to the program, successfully providing a function as a host device that issues a control command to the memory card 200 or controls writing and reading data in the memory card 200. The card controller 130 and the memory card 200 are coupled to each other through the cardbus 20. The CPU 110 controls a control command generation to be issued to the memory card 200 from the card controller 130. When the memory card 200 is defined as a device, the card controller 130 can be defined as a host controller that controls a host side.

The cardbus 20 includes a clock line to which a transfer clock CLK is transmitted, a command line to which a control command CMD and a response are transmitted, and a data line to which a transfer data DAT0-DAT3 in 4 bits (or 8 bits), for example, is transmitted. In this embodiment, the card controller 130 issues the command CMD in synchronization with the transfer clock CLK. Then, in synchronization with the transfer clock CLK, for example, the transfer data DAT0-DAT3 in 4 bits is transmitted and received. Further, depending on a type of the command CMD, the memory card 200 can send back a response by using a command line, for example, as a response to the control command CMD.

In the following description, the memory card 200 is a flash memory card complying with the SD standard, and transmits and receives a control command, a response, and transfer data to/from the cardbus 20 according to a sequence complying with the SD standard.

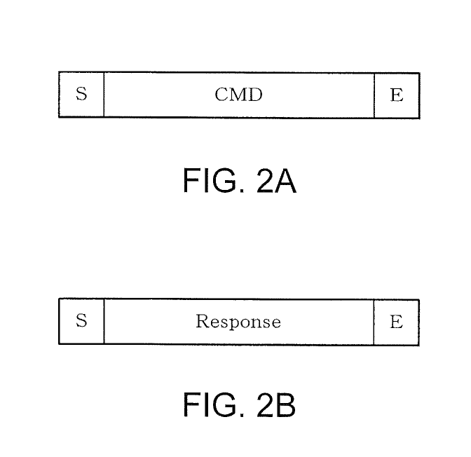

FIG. 2A shows a diagram describing the control command according to the embodiment.

The control command is 48 bit data, for example, and includes 45-bit command data, and an end bit E “1”, in addition to a start bit S (“0”) and a transfer bit “1” arranged by a card controller 130. The trailing 7 bits in the command data are Cyclic Redundancy Check (CRC) data. The command data can include commands, information about addresses and parameters, and data having a structure such as one shown in FIG. 2 is transmitted through the command line.

FIG. 2B shows a diagram describing the response transmitted from the memory card 200 corresponding to the control command in FIG. 2A.

The response is response data being in a predetermined bit and provided between a start bit S that is “0” and an end bit E that is “1”. The response shown in FIG. 2B is received through the command line. If the transfer bit is arranged to be “0” for example, the memory card 200 can transmit the response by return to the card controller 130 through the command line described above.

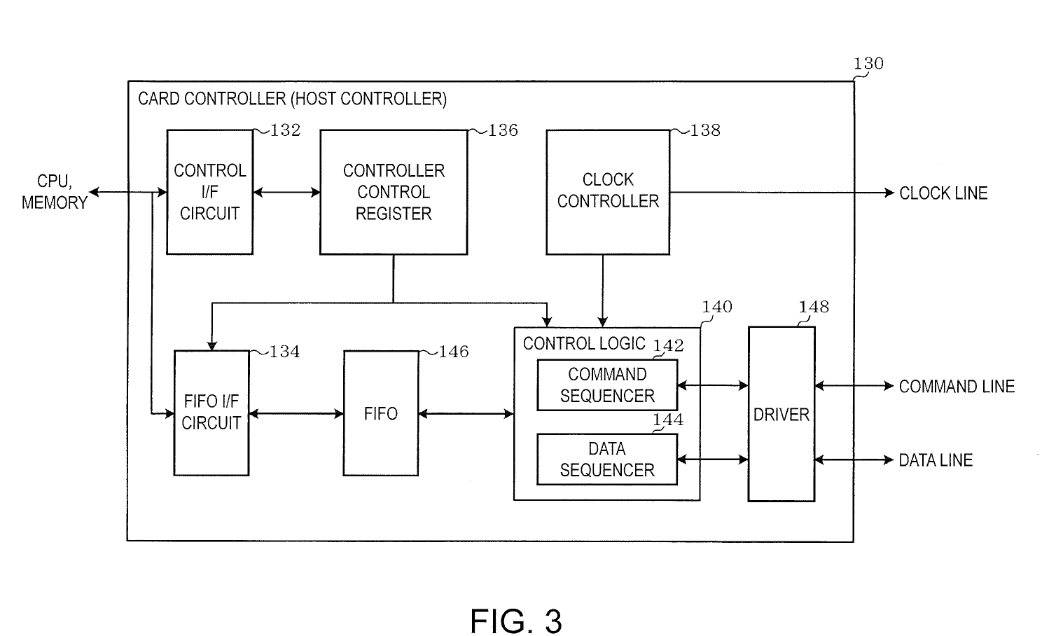

In FIG. 3, a block diagram showing an example structure of the card controller 130 shown in FIG. 1.

The card controller 130 includes a control interface (I/F) circuit 132, a First-In First-Out (FIFO) I/F circuit 134, a controller control register 136, a clock controller 138, a control logic 140, a FIFO (FIFO memory, or buffer) 146, and a driver 148. The control logic 140 includes a command sequencer 142, and a data sequencer 144.

The control I/F circuit 132 performs interface processing for a control signal and control data transmitted to and received from the CPU 110 and the memory 120 via the systembus 122. The CPU 110 can set the control data to each control register of the controller control register 136 via the control I/F circuit 132.

The FIFO I/F circuit 134 performs interface processing of the control signal and control data transmitted to and received from the CPU 110 and the memory 120 via the systembus 122. The data read from the memory 120 via the systembus 122 is buffered at the FIFO 146, and then provided to the control logic 140. Further, the data read from the memory card 200 is buffered at the FIFO 146, and then output to the CPU 110 or the memory 120 via the systembus 122. The FIFO 146 does not necessarily include a so-called First-In-First-Out structure, but may be a memory allowing a random access.

The controller control register 136 has one or more of control registers, and sets control data to each control register so as to control the card controller 130. Based on control signals corresponding to the control data set in each control register of the controller control register 136, each part of the card controller 130 is controlled.

The clock controller 138 supplies a clock to each part of the card controller 130, while controls an output of the transfer clock CLK to a clock line forming the cardbus 20.

The command sequencer 142 controls an issue of a command with respect to the memory card 20 via the command line forming the cardbus 20 based on the control data of the control register of the controller control register 136.

The data sequencer 144 controls a transmission and reception of the data to/from the memory card 200 via the data line forming the cardbus 20 based on the control data of the control register of the controller control register 136.

The driver 148 controls input and output of a signal of the command line based on a control result of the command sequencer 142. Further, the driver 148 controls input and output of a signal of the data line based on a control result of the data sequencer 144.

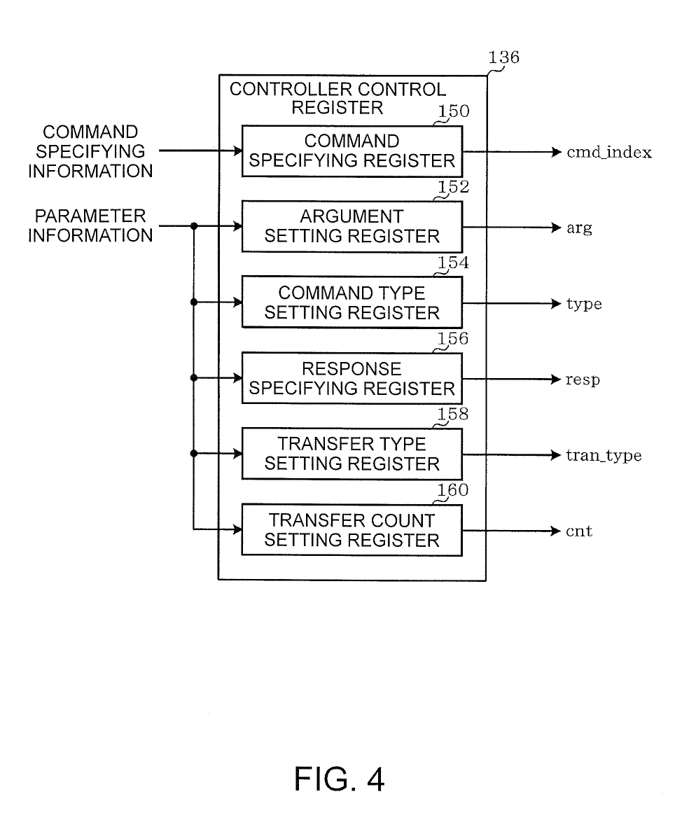

In FIG. 4, a structure of the controller control register 136 in FIG. 3 is schematically shown.

The controller control register 136 can include a command specifying register 150, an argument setting register 152, a command type setting register 154, a response specifying register 156, a transfer type setting register 158, and a transfer count setting register 160. Each control register of the command specifying register 150, the argument setting register 152, the command type setting register 154, the response specifying register 156, the transfer type setting register 158, and the transfer count setting register 160 of the controller control register 136 has an address that is respectively allocated. Therefore, for example, simply incrementing the address (or by adding a value of a predetermined address) enables sequential access the control registers.

The CPU 110 can set command specifying information for specifying a command type to be issued to the memory card 200, and parameter information that is a parameter for the command to the controller control register 136 via the systembus 122. The parameter information can include argument information, command type information, response specifying information, transfer type information, and transfer count information.

The command specifying information is set in the command specifying register 150. Based on the command specifying information set in the command specifying register 150, a control signal cmd_index is output. A command index specified by the control signal cmd_index is to be an index for a command in the SD standard (e.g. refer to SD Specifications, Part 1, Physical Layer Specification Version 2.00, May 9, 2006, 4.7.4 Detailed Command Description). For example, when the command index specified by the control signal cmd_index specifies “0” (zero), the card controller 130 issues a command CMD0 to the memory card 200 so as to be in an idling state.

Among the parameter information, the argument information is set in the argument setting register 152. Based on the argument information set in the argument setting register 152, a control signal arg is output. The argument information specified by the control signal arg is an argument of the command in the SD standard. By using the argument specified by the control signal arg, the card controller 130 issues a command that includes the argument above such as CMD2 (the command index is “2”, for example) to the memory card 200.

Among the parameter information, the command type information is set in the command type setting register 154. Based on the command type information set in the command type setting register 154, a control signal type is output. The command type information includes information indicating a stop command or not, and for example, information indicating ACMD or not (CMD or ACMD) in the SD standard.

Among the parameter information, the response specifying information is set in the response specifying register 156. Based on the response specifying information set in the response specifying register 156, a control signal resp is output. The response specifying information specified by the control signal resp is a response type of the command. The response type is information specifying not only presence of a response, but also a type of response sequence in a case where the response is received. Here, for example, if a response type other than R1 in the SD standard is specified, a response type R6 or R7 having the substantially same sequence can be specified as R1. For example, when the response specifying information specified by the control signal resp specifies “R1b” (the command index is “7”, for example), the card controller 130 issues the command CMD7 to the memory card 200 so as to receive a response in which the memory card 200 is in a busy state.

Among the parameter information, a transfer type is set in the transfer type setting register 158. Based on the transfer type information set in the transfer type setting register 158, a control signal tran_type is output. The transfer type information specified by the control signal tran_type is a transfer type of the command in the SD standard. The transfer type information includes a transfer direction, and information if a control command 12 is included or not, in addition to a single transfer, a multiple transfer, a stream transfer, and an infinite transfer.

Among the parameter information, the transfer count information is set in the transfer count setting register 160. Based on the transfer count set in the transfer count setting register 160, a control signal cnt is output. Based on the transfer count specified by the control signal cnt, the card controller 130 repeats data transfer to/from the memory card 200.

The card controller 130 can issue a control command to the memory card 200 according to the control data of each control register in the controller control register 136 as shown in FIG. 4.

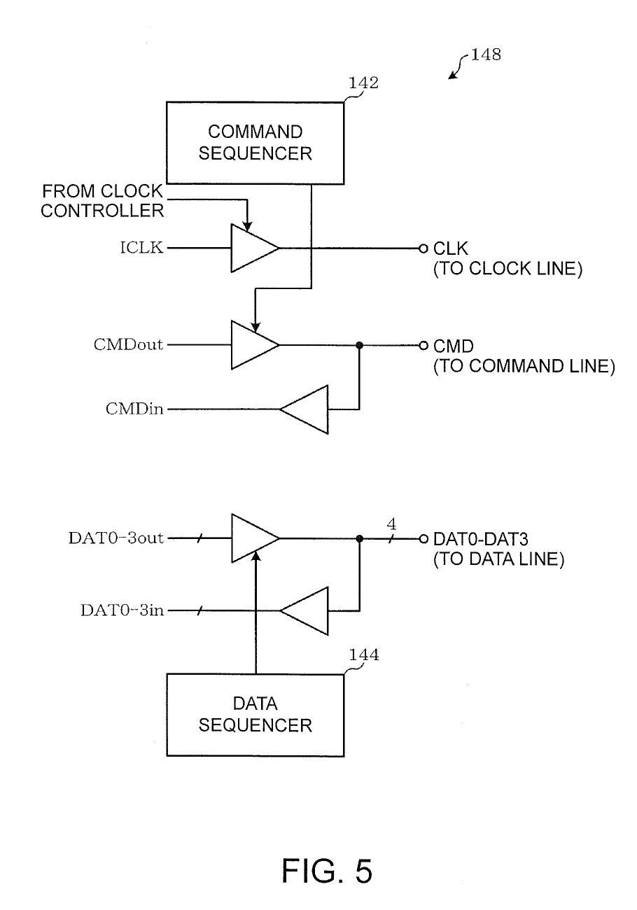

FIG. 5 schematically shows a structure of the driver 148 shown in FIG. 3.

The driver 148 includes a driver outputting a transfer clock SDCLK by driving the clock line, a first input-output driver coupled to the command line, a second input-output driver coupled to the data line.

The first input-output driver includes an output driver and an input driver. The output driver is controlled by the command sequencer 142 and outputs a control command by driving the command line, while the input driver receives a response being input via the command line. Based on the control register of the controller control register 136, the control command generated by the command sequencer 142 is output to the command line by the output driver of the first input-output driver. Then, the response output from the memory card 200 corresponding to the control command is received by the input driver of the first input-output driver.

The second input-output driver includes an output driver and an input driver. The output driver is controlled by the data sequencer 144 and outputs transfer data by driving the data line, while the input driver receives transfer data being input via the data line. Based on the control register of the controller control register 136, data from the FIFO I/F circuit 134 is output to the data line as the transfer data by control of the data sequencer 144 via the output driver of the second input-output driver. Then, the response output from the memory card 200 is received by the input driver of the first input-output driver.

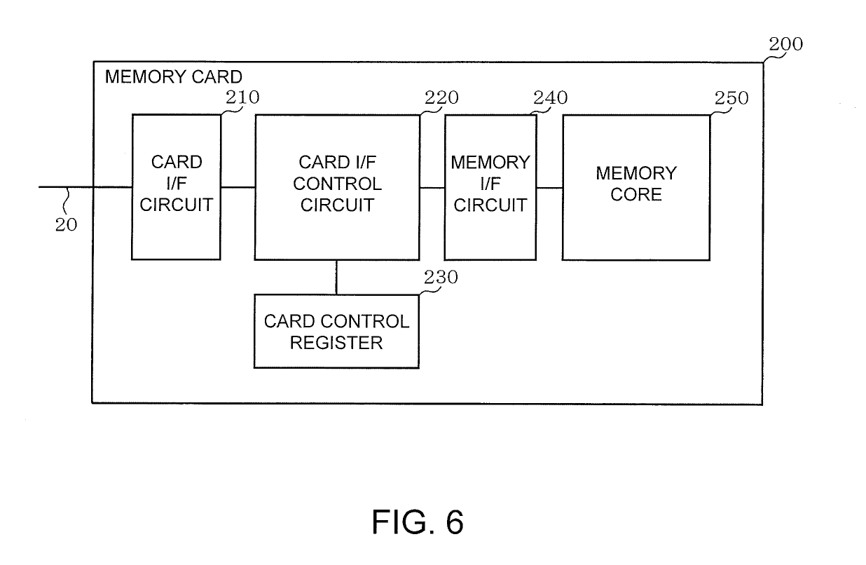

FIG. 6 is a block diagram showing an example structure of the memory card 200 shown in FIG. 1.

The memory card 200 includes a card I/F circuit 210, a card I/F control circuit 220, a card control register 230, a memory I/F circuit 240, and a memory core 250.

The card I/F circuit 210 performs interface processing of a signal to be transmitted to the cardbus 20. The card I/F control circuit 220 controls the card I/F circuit 210 so as to output a signal to the cardbus 20, and input a signal from the card bus 20.

The card control register 230 has a plurality of control registers. For example, the card control register 230 includes an operation conditions resister (OCR), a card identification register (CID), a card-specific data register (CSD), a relative card address register (RCA), a driver stage register (DSR), an SD configuration register (SCR), an SD status register (SSR), and a card status register (CSR). The card I/F control circuit 220 controls each part of the memory card 200 based on the setting data of the card control register 230 and stores the control result in the card control register 230.

The memory I/F circuit 240 controls writing data in a memory element of the memory core 250 and reading data from the memory element of the memory core 250 based on control of the card I/F control circuit 220.

The memory core 250 includes a plurality of memory elements. The memory I/F circuit 240 can read data from a memory element corresponding to an address allocated in advance, and write data into a memory element corresponding to the address.

2. Host Device

Here, a host device that can be applicable to a host device 126 shown in FIG. 1 in the embodiment will be described.

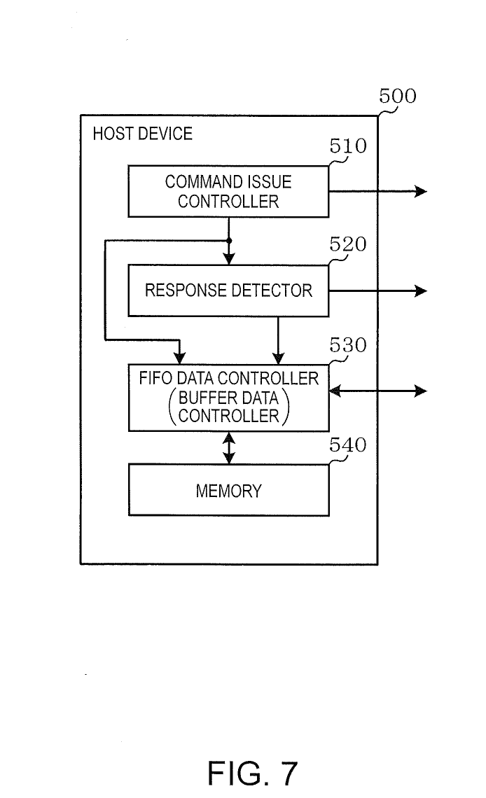

FIG. 7 schematically shows a structure of the host device according to the embodiment.

A host device 500 includes a command issue controller 510, a response detector 520, a FIFO data controller (buffer data controller in a broad sense) 530, and a memory 540.

Functions of the command issue controller 510, the response detector 520, and the FIFO data controller 530 are achieved by the CPU 110 and the memory 120 shown in FIG. 1. More specifically, the CPU 110 reads a program stored in the memory 120 and executes a process corresponding to the program, thereby achieving the functions of the command issue controller 510, the response detector 520, and the FIFO data controller 530. The function of the memory 540 is realized by the memory 120 shown in FIG. 1.

The command issue controller 510 issues a command to the card controller 130 for accessing the memory card 200. More specifically, according to an order from an upper application program, the command issue controller 510 set the command specifying information and the parameter information in the controller control register 136 of the card controller 130 in FIG. 4 and controls the memory card 200 so as to issue a command.

The response detector 520 detects a reception of a response from the memory card 200 corresponding to the command issued by the command issue controller 510. More specifically, when the command issued by the command issue controller 510 is a command that should receive a response from the memory card 200, the response detector 520 detects presence of the response received by the card controller 130. When receiving the response from the memory card 200, the card controller 130 can inform the reception of the response from the memory card 200 to the host device 500 by interrupting the host device 500, or setting a flag of a status register that is not shown. The response detector 520 can detect whether the memory card 200 outputs the response to the card controller 130 or not by polling such an interrupting notice from the card controller 130 or information of the status register.

When the command issued from the command issue controller 510 is a write command, the FIFO data controller 530 performs write control to write writing data that should be output to the memory card 200 in FIFO 146 of the card controller 130. More specifically, when the write command is issued, the FIFO data controller 530 writes the writing data stored in the memory 540 to the FIFO146.

Further, when the command issued from the command issue controller 510 is a read command, the FIFO data controller 530 performs read control to read reading data that should be read from the memory card 200 through the FIFO 146 of the card controller 130. That is, when the read command is issued, the FIFO data controller 530 controls writing the reading data from the FIFO146 to the memory 540.

Then, after the command issue controller 510 issues the command, the FIFO data controller 530 performs reading or writing once or more by a predetermined data size unit corresponding to the command. In other words, in a case where the command issue controller 510 issues a given command, when the command needs to receive a response, the response detector 520 can detect a reception of the response after the command issue control. Further, when the command needs to output writing data, the FIFO data controller 530 writes the writing data once or more to the FIFO146 after the command issue control. Furthermore, the command needs to input reading data, the FIFO data controller 530 reads the reading data once or more after the command issue control. As the above, corresponding to a type of the command issued by the command issue controller 510, even when control sequences such as presence of a reception of the response, presence of an output of the writing data, presence of an input of the reading data vary, a control that is required can be simply operated corresponding to the command since the command issue control, the response receiving control (detecting reception), and the input-output data of the FIFO data are separated. That is, by each command, the command issue controller 510, the response detector 520, and the FIFO data controller 530 can be commonly used. Further, the command issue controller 510 may include the response detector 520, or the FIFO data controller 530 may include the response detector 520.

By the way, there is a case where transfer is not completed depending on an accumulation status of the data in the FIFO 146 of the card controller 130, or due to decrease of the data transfer efficiency. For example, in a writing action, when the FIFO 146 of the card controller 130 is full, the data is output from the card controller 130 to the memory card 200, thereby the transfer clock CLK does not need to be stopped. On the contrary, in a reading action, when the FIFO 146 of the card controller 130 is full, if the transfer data from the memory card 200 is received by the card controller 130, the data may not be correctly received. Therefore, the card controller 130 needs to stop the transfer clock CLK so as to stop outputting of the reading data from the memory card 200. At this time, a response also cannot be received by the card controller 130. Therefore, it is desirable that the host device 500 that reads data in FIFO 146 of the card controller 130 control reading so as not to make the FIFO 146 full as much as possible.

However, the MMC standard, the SD standard, SDIO standard, the CE-ATA standard or the like include cardbus specifications as below.

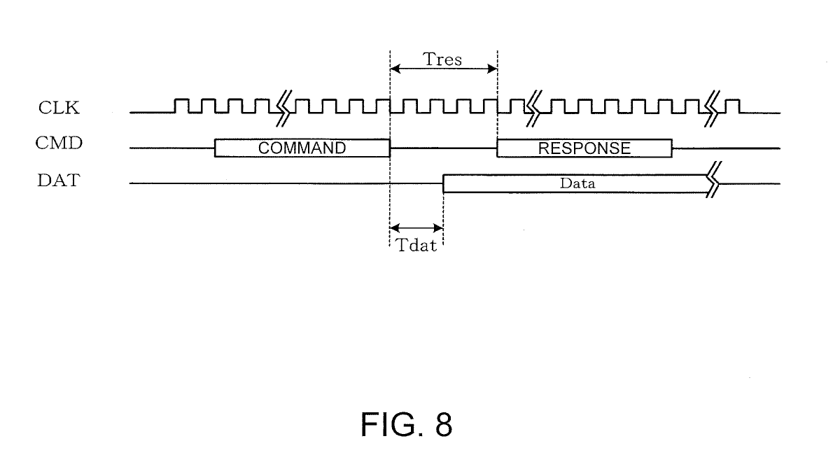

FIG. 8 shows a diagram describing a cardbus specification in the MMC standard or the like described above.

FIG. 8 shows an example of timing of which a clock line to which a transfer clock CLK is transmitted, a command line to which a command and a response are transmitted, and a data line to which a transfer data DAT0-3 is transmitted.

If the card controller 130 issues a command (read command) via the command line, in the MMC standard or the like described above, the memory card 200 can output data after a period Tdat corresponding to at least 2 clocks of the transfer clock CLK with reference to an end bit of the command. On the other hand, in the MMC standard or the like as above, the memory card 200 does not need to send back a response until after a period Tres corresponding to at most 64 clocks of the transfer clock CLK with reference to the end bit of the command. Therefore, as shown in FIG. 8, during a period from when a transfer data is read by the data line to when a start bit is detected at the card controller 130, the transfer data is buffered in the card controller 130.

Unless the host device 126 reads the transfer data buffered in the card controller 130, the FIFO 146 of the card controller 130 becomes full, resulting in stopping output of the transfer clock CLK. During this period, if the output of the transfer clock is stopped, it is possible that even the start bit of the response cannot be received.

Therefore, in the embodiment, even in a case shown in FIG. 8, the host device that is controllable so as to securely receive a response without stopping the transfer clock. Therefore, even when data starts being received before a response corresponding to an issued command is received, a size of the receiving data before the response is received is obtained as a pre-read size so that the data transfer is continued afterwards. That is, the host device 500 can update the pre-read size while reading the data buffered in the FIFO 146 during a period before receiving the response. Then, when the reception of the response is completed, the host device 500 continues to read the data from the FIFO 146 using the pre-read size.

More specifically, the FIFO data controller 530 of the host device 500 stores the data read from the FIFO 146 in the memory 540, and obtains a size of the data to be stored in the memory 540 as the pre-read size during the period from when the command is issued to when the card controller 130 completely receives a response from the memory card 200 corresponding to the command. Then, after the reception of the response is completed, the data read from the FIFO 146 is sequentially stored in a memory region of the memory 540 that is shifted for the pre-read size. According to the above, the data is read from the FIFO 146 until the reception of the response is completed, and further the FIFO 146 is prevented from being full. Then, after the reception of the response is completed, the data is continuously read from the FIFO 146, reducing a transfer time for the reading action.

2.1 Command Issue Controller

In order to simplify setting of the parameter information corresponding to various commands for the MMC standard, the SD standard, SDIO standard, CE-ATA standard, and the like, the command issue controller 510 in FIG. 7 has a command table, and command setting information registered in the command table is set to the controller control register 136 in FIG. 4 as it is, thereby simplifying complicated command issue control.

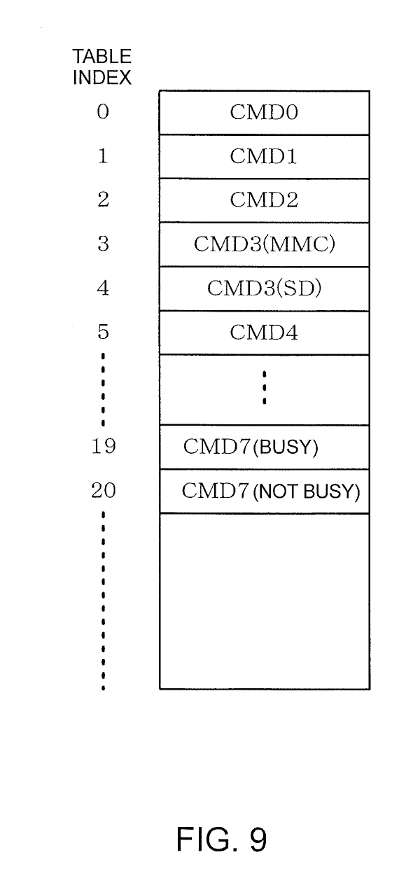

FIG. 9 schematically shows a structure of the command table according to the embodiment.

As shown in FIG. 9, the command table includes a plurality of blocks. Each of the blocks has a table index that is allocated. Then, in each block, command setting information of the command is registered.

In FIG. 9, for example, command setting information for issuing a command CMD0 of the SD standard is registered in a block corresponding to a table index “0”. Similarly, for example, command setting information for issuing a command CMD1 of the SD standard is registered in a block corresponding to a table index “1”. Further, similarly, for example, command setting information for issuing a command CMD3 of the MMC standard is registered in a block corresponding to a table index “3”, while command setting information for issuing a command CMD3 of the SD standard is registered in a block corresponding to a table index “4”.

In addition, as shown in FIG. 9, it is preferable that the table index and the command index be different from each other. That is, it is not necessary to give the same numbers to the table index and the command index. According to the above, as long as the table index is understood, a process for generating control commands is prevented from being complicated even when a block to register the command setting information is newly added or changed.

Further, in the command table, command setting information for control commands of various standards can be mixed and registered into each table. That is, it is preferable to include the command setting information corresponding to the control command defined by a first standard and the command setting information corresponding to the control command defined by a second standard. As shown in FIG. 9, for example, in addition to the control command of the SD standard, the control command of the MMC standard that is backward compatible with the SD standard or the like, the control command of the SDIO standard, and the control command of the CE-ATA standard are preferably mixed. Accordingly, a table index is simply specified in order to issue a command in any one of the plurality of the standards, thereby simplifying processes and reducing an amount of programming codes compared to processes for generating control commands in related art.

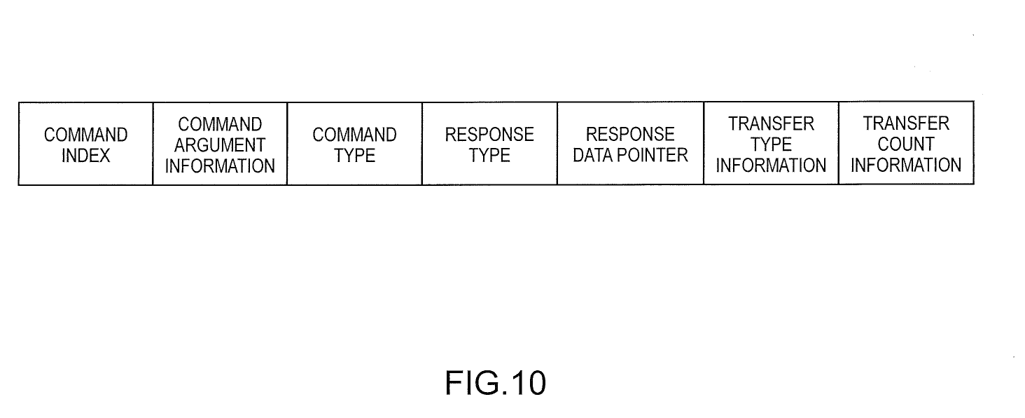

FIG. 10 shows an example of the command setting information registered in each block shown in the command table in FIG. 9.

In each block, the command setting information is registered. Then, each command setting information is formed for each combination of a command index as command specifying information and parameter information. In each block, command argument information, a command type (command type information), a response type, a response data pointer, transfer type information, and transfer count information are registered in addition to the command index. The response data pointer is information for specifying a memory region of the memory 540 (memory 120) in which response data from the memory card 200 is to be stored. The command specifying information and the parameter information except for the response data pointer is set to each control register in the controller control register 136 as it is.

Here, an order in which the command specifying information and the parameter information for each command setting information is stored is preferably the same as an order of an address that specifies the control register of the controller control register 136 of the card controller 130 in which the command specifying information and the parameter information is set. Further, an alignment sequence of each information of the command specifying information and the parameter information for each command setting information is preferably the same as that of a bit field of the control register of the controller control register 136 of the card controller 130 in which the information is set.

According to the above, each information in FIG. 10 can be set to each control register of the controller control register 136 in FIG. 4 without processing and a bit operation except for the response data pointer. Therefore, the process for generating the control commands is simplified.

2.2 Processing Example

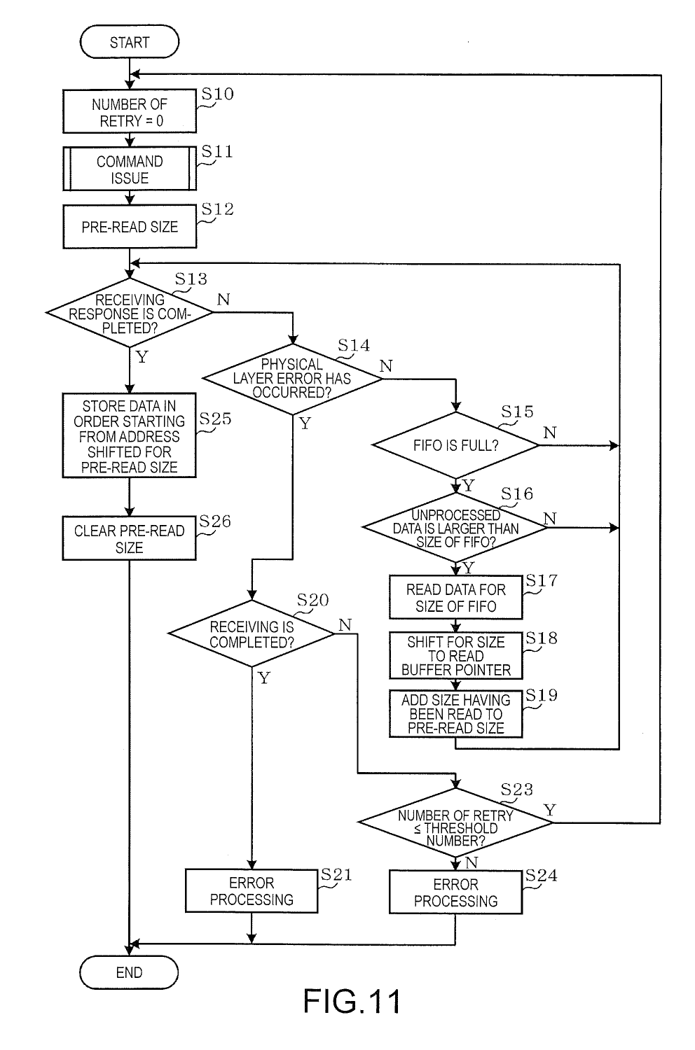

FIG. 11 is a flowchart illustrating an operation example of the host device 500 shown in FIG. 7.

In a case where the host device 500 in FIG. 7 is employed to the host device 126 in FIG. 1, a program to execute a process shown in FIG. 11 is stored in the memory 120 shown in FIG. 1. The CPU 110 reads the program from the memory 120 so as to execute the process corresponding to the program, controlling the card controller 130, so that the process shown in FIG. 11 is executeed.

First, the host device 500 initializes a retry number that is a parameter, and then sets the retry number to “0”.

Next, the host device 500 issues a command (read command) at the command issue controller 510 (Step S11). Then, the host device 500 initializes a pre-read size that is a parameter, and sets the pre-read size to “0” (Step S12). In the host device 500, for example, the FIFO data controller 530 controls the pre-read size.

Next, the host device 500 waits for that a response from the memory card 200 corresponding to a command (read command) issued in Step 10 is completely received at the response detector 520 (Step S13). The completion of receiving the response is recognized by detecting a reception of a correct end bit for the response. According to the above, the memory card 200 starts outputting reading data to the card controller 130 by synchronizing to the transfer clock. In the card controller 130, buffering the reading data to the FIFO 146 is started.

In Step 13, when the completion of receiving the response from the memory card 200 is not detected (Step S13:N), the host device 500 identifies, for example, whether a physical layer error is generated or not at the response detector 520 (Step S14). The physical layer error includes a CRC error of the response that is detectable at the response detector 520.

In Step 14, when the physical layer error is not detected (Step S14:N), the FIFO data controller 530 identifies whether the FIFO 146 of the card controller 130 is full or not (Step S15).

In Step S15, if it is identified that the FIFO 146 is not full (Step S15: N), the completion of receiving the response is detected by going back to Step 13. In Step 15, if it is identified as that the FIFO 146 is full (Step S15:Y), a size of unprocessed data in the data size supposed to be processed by the command issued at Step 11 is detected whether it is more than or equal to a whole size of the FIFO 146 (a data size that the FIFO 146 can store) or not (Step S16).

In Step S16, if it is identified that the size of the unprocessed data is not more than or equal to the whole size of the FIFO 146 (Step S16: N), the completion of receiving the response is detected by going back to Step 13.

In Step 16, if it is identified that the size of the unprocessed data is more than or equal to the whole size of the FIFO 146 (Step S16:Y), the FIFO data controller 530 only reads the data corresponding to the whole size of the FIFO 146 (Step 17), and stores the data from the FIFO 146 in the memory 540. The memory region of the memory 540 where the data from the FIFO 146 is stored is controlled by a buffer pointer of the memory 540. Afterwards, the FIFO data controller 530 shifts the buffer pointer by an amount to read the FIFO 146 (Step 18), followed by updating by adding an amount of the size that is read for the pre-read size (Step S19), and going back to Step 13.

As the above, only when the FIFO 146 is full, and the size of the unprocessed data is more than or equal to the whole size of the FIFO, the data of the FIFO 146 is read. Therefore, the reading control (control of the pre-read size) of the FIFO 146 is simplified, and further, unnecessary reading is avoided.

On the other hand, in Step 14, when occurrence of the physical layer error is detected (Step S14:Y), if the receiving data has been already received (Step S20:Y), given error processing is performed (Step S21), so that this series of the processes terminates (end). Here, as for the error processing, the host device 500 processes interrupt handler that needs to be processed when the physical layer error occurs. In Step S20, when the receiving data has not been received yet (Step S20: N), the host device 500 increases the number of retry (Step S21) and checks if the number of retry after being increased is less than or equal to a predetermined threshold number or not (Step S23).

In Step S23, if it is identified that the number of retry after being increased is less than or equal to the predetermined threshold number (Step S23: Y), the host device 500 detects the completion of receiving the response after going back to Step 13.

In Step S23, if it is identified that the number of retry after being increased is more than the predetermined threshold number (Step S23: N), the host device 500 performs error processing (Step S24), so that the series of the processes terminates (end). Here, as for the error processing, the host device 500 processes interrupt handler for preventing an infinite loop when the physical layer error occurs.

Further, in Step S13, when the completion of receiving the response from the memory card 200 is detected (Step S13: Y), the host device 500 stores data being read from the FIFO 146 sequentially from the buffer pointer (address) that has been shifted for the amount of the pre-read size (Step S25), and clears the pre-read size (Step S26), so that the series of the processes terminates (end).

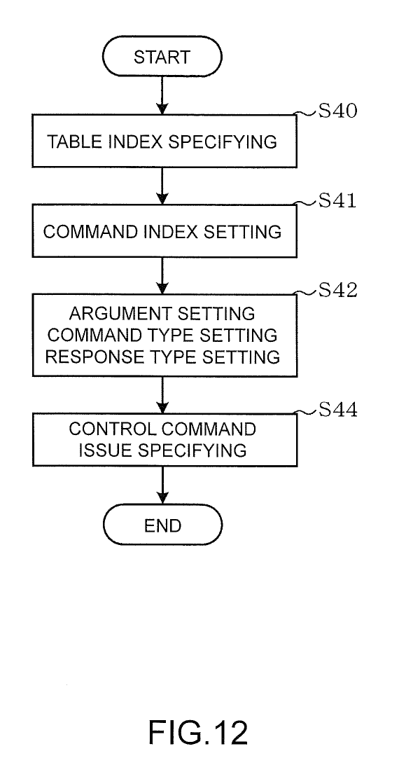

FIG. 12 is a flowchart illustrating an example of the process for Step S11 shown in FIG. 11.

In a case where the host device 500 in FIG. 7 is employed to the host device 126 in FIG. 1, a program to execute the process shown in FIG. 12 is stored in the memory 120 shown in FIG. 1. The CPU 110 reads the program from the memory 120 so as to execute the process corresponding to the program, controlling the card controller 130, so that the process shown in FIG. 12 is executed.

The command issue controller 510 of the host device 500 specifies a table index in the command table corresponding to the control command to issue as required according to an order from the upper application program (Step S40), and then sets a command index picked up from the command setting information of a block specified by the table index to the command specifying register 150 in the controller control register 136 (Step S41).

Then, the CPU 110 sets the argument information picked up from the command setting information of the block specified by the table index to the argument setting register 152 of the controller control register 136, followed by setting a command type to the command type setting register 154 of the controller control register 136, and setting a response type to the response specifying register 156 of the controller control register 136 (Step S42). Further, the CPU 110 sets the transfer type information to the transfer type setting register 158 while setting the transfer count information to the transfer count setting register 160.

Next, the CPU 110 directs an issue of the control command by accessing the control command issue direction register (not illustrated) of the controller control register 136 in the card controller 130 (Step S44), so that the series of the processes terminates (end).

As the above, the host device 500 controls reading of the reading data of the FIFO 146 in the card controller 130.

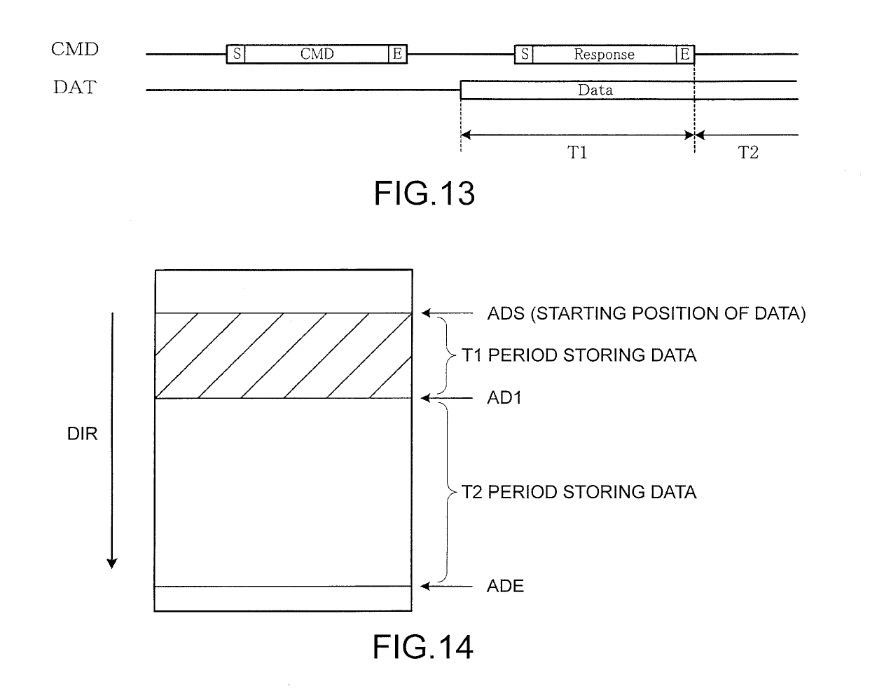

FIG. 13 is a diagram describing an advantageous effect of the embodiment.

As shown in FIG. 13, in the embodiment, when a response is sent back after an issue of a read command, reading the reading data of the memory card 200 from the FIFO 146 in the card controller 130 is controlled while the pre-read size is updated during the period T1 until an end bit of the response is received. The reading data having been read during the period T1 is stored in the memory 540.

Then, during a period T2 after receiving the end bit of the response, the reading control to read the reading data in the memory card 200 from the FIFO 146 is continued by using the pre-read size. More specifically, in the period T2, the reading data from the FIFO 146 is continuously stored in the memory 540 in order starting from a start address to which the pre-read size obtained in the period T1 is corrected as an offset of the memory 540.

FIG. 14 is a diagram describing an address of the memory 540.

As shown in FIG. 14, when a direction of an ascending order of the address specifying the memory region of the memory 540 is a direction shown by an arrow DIR, the data is stored in order from a start address ADS showing a starting position of the data in the period T1 in FIG. 14. At this time, every time that the data is stored, the pre-read size is updated by simply adding a size of the storing data.

In the period T2, with reference to the start address ADS, the data from an address AD1 that has an offset for the amount of the pre-read size to an end address ADE showing an final position of the data is read as reading data from the FIFO 146 and stored in the memory 540 in order.

As described in the above, according to the embodiment, the data is read from the FIFO 146 until the response is completely received, while the FIFO 146 is prevented from being full. Therefore, without stopping the transfer clock due to the FIFO 146 being full, after the reception of the response is completed, the data is continuously read from the FIFO 146, thereby reducing a transfer time for the reading action. Further, a capacity of the FIFO 146 can be reduced, contributing cost reduction of the card controller 130.

3. Electronic Apparatus

Next, an example structure of an electronic apparatus employing the host device according to the embodiment is described.

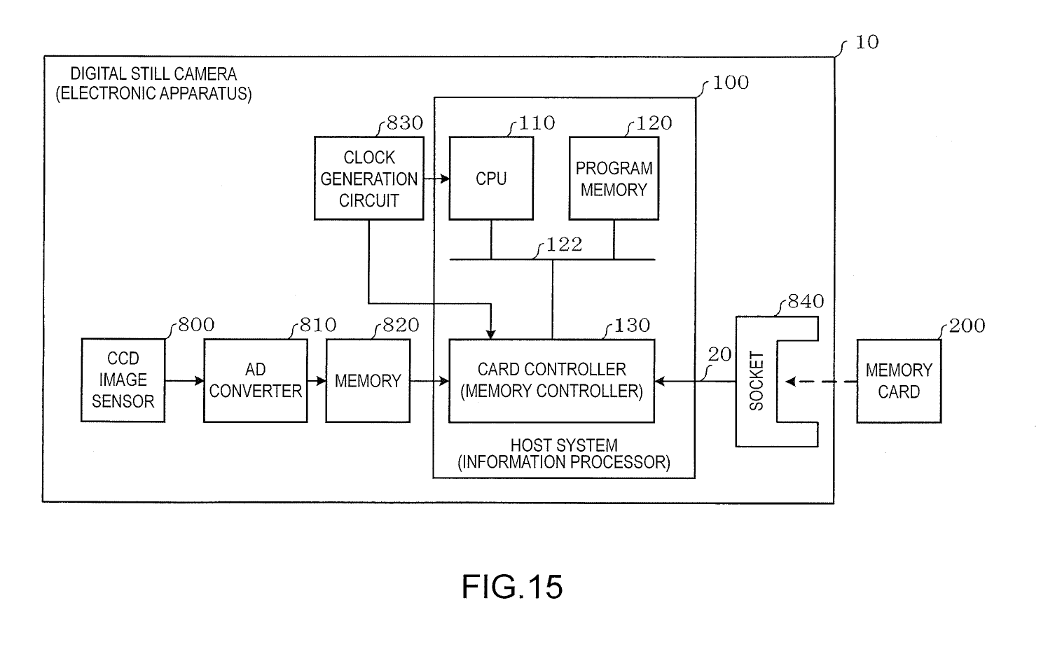

FIG. 15 is a block diagram showing an example structure of a digital still camera as the electronic apparatus according to the embodiment.

The parts same as shown in FIG. 1 are given the same numerals in FIG. 15 and the explanation thereof will be omitted here.

An electronic apparatus 10 includes a charge coupled device (CCD) image sensor 800, an AD converter, a memory 820, a clock generation circuit 830, a host system 100, and a socket (a slot, a memory inserting portion, a card inserting portion, a memory card inserting portion, and a storage device inserting portion) 840.

The CCD image sensor 800 includes a plurality of light receiving elements, and converts image data to an electric signal by reading an electric charge generated by incident light entered into each of the light receiving elements. The image data converted into the electric signal by the CCD image sensor 800 is converted into a digital signal by the AD converter 810, and then buffered in the memory 820 afterwards.

The clock generation circuit 830 generates a basic clock of the electronic apparatus 10 and a basic clock of the host system 100.

A program memory 120 in FIG. 15 serves as the memory 120 in FIG. 1.

In the socket 840, the memory card 200 is inserted and ejected. While the memory card 200 is inserted in the socket 840, an access complying with the SD standard is performed between the card controller 130 and the memory card 200 via the cardbus 20.

Further, due to control of the host system 100, the image data stored in the memory 820 is written into the memory card 200, or the image data from the memory card 200 is read and stored in the memory 820.

According to the electronic apparatus 10 in FIG. 15, when the data is read from the memory card 200, the reading data is obtained in a short time without stopping the transfer clock.

It should be noted that the invention is not limited to the above-mentioned embodiment, and various changes can be made within the scope of the invention. The memory card in the embodiment is not limited to the flash memory card. The memory card in the embodiment can be replaced by an I/O device, an HDD device, a DVD device, or an optical disc device.

Further, the command is not limited to the commands described in the embodiment above. The invention can be employed to, for example, a writing action based on standards having similar ideas to the SD standard or on standards that have been developed from the SD standard, a writing action based on standards having similar ideas to the MMC standard or on standards that have been developed from the MMC standard, a writing action based on standards having similar ideas to the SDIO standard or on standards that have been developed from the SDIO standard, and a writing action based on standards having similar ideas to the CE-ATA standard or on standards that have been developed from the CE-ATA standard.

As for the dependent claims of the invention, it is possible to omit part of the elements claimed in a claim on which they depend. Moreover, a feature claimed in one of the independent claims of the invention may be dependent on another independent claim.

What is claimed is:

1. A host device for controlling a storage device controller to access a storage device, the host device comprising:
a command issue controller controlling an issue of a command for allowing the storage device controller to access the storage device;
a response detector for detecting a reception of a response from the storage device corresponding to the command; and
a buffer data controller controlling reading and writing of a buffer of the storage device controller, the buffer storing one of reading data and writing data of the storage device, wherein the buffer data controller controls one of the reading and the writing at least once in a predetermined data size unit corresponding to the command after the command issue controller issues the command.

2. The host device according to claim 1, wherein the buffer data controller stores the data being read from the buffer in a given memory, obtains a size of the data to be stored in the memory during a period from an issue of the command to a completion of receiving the response for the storage device controller from the storage device as a pre-read size corresponding to the command, and stores the data being read from the buffer in order starting from a storage region of the memory that is shifted for the pre-read size after the response is completely received.

3. The host device according to claim 2, wherein if the storage device controller outputs a transfer clock as a transfer synchronous clock to the storage device, and stops outputting the transfer clock when the buffer is full, the buffer data controller reads the data from the buffer that is full and updates the pre-read size by adding a size of the data.

4. The host device according to claim 3, wherein the buffer data controller reads the data from the buffer and updates the pre-read size if the buffer is full, and a size of the data to be read from the storage device specified by the command is more than or equal to a data size that is storable in the buffer.

5. The host device according to claim 4, wherein the buffer data controller reads data from the buffer in a data size unit that is a storable in the buffer.

6. An information processor, comprising: the storage device controller including the buffer buffering data from the storage device; and the host device according to claim 1, the host device controlling an issue of the command to the storage device controller.

7. An electronic apparatus, comprising:
a storage device inserted portion from which the storage device is inserted and ejected; and
the information processor according to claim 6.

8. A program for controlling a storage device controller to access a storage device, the program comprising:
an operating command for instructing a computer to serve as:
a command issue controller to control an issue of a command for allowing the storage device controller to access the storage device;
a response detector to detect reception of a response from the storage device corresponding to the command; and
a buffer data controller to control reading and writing of a buffer of the storage device controller, the buffer storing one of reading data and writing data of the storage device, wherein the buffer data controller controls one of the reading and the writing at least once in a predetermined data size unit corresponding to the command after the command issue controller issues the command.

9. The program according to claim 8, wherein the buffer data controller stores the data being read from the buffer in a given memory, obtains a size of the data to be stored in the memory during a period from an issue of the command to a completion of receiving the response for the storage device controller from the storage device as a pre-read size corresponding to the command, and stores the data being read from the buffer in order starting from a storage region of the memory that is shifted for the pre-read size after the response is completely received.

10. The program according to claim 9, wherein if the storage device controller outputs a transfer clock as a transfer synchronous clock to the storage device, and stops outputting the transfer clock when the buffer is full, the buffer data controller reads the data from the buffer that is full and updates the pre-read size by adding a size of the data.

11. The program according to claim 10, wherein the buffer data controller reads the data from the buffer and updates the pre-read size if the buffer is full, and a size of the data to be read from the storage device specified by the command is more than or equal to a data size that is storable in the buffer.

12. The program according to claim 11, wherein the buffer data controller reads data from the buffer in a data size unit that is a storable in the buffer.

13. A method for controlling reading for a storage device controller buffering reading data from a storage device, the method comprising:
a) controlling an issue of a command for allowing the storage device controller to access the storage device;
b) detecting a reception of a response from the storage device corresponding to the command; and
c) controlling reading and writing of a buffer of the storage device controller, the buffer stores one of reading data and writing data of the storage device, wherein the step c) includes controlling one of the reading and the writing at least once in a predetermined data size unit corresponding to the command after the command issue controller issues the command.

14. The method for controlling reading according to claim 13, wherein the step c) further includes:
storing the data being read from the buffer in a given memory;
obtaining a size of the data to be stored in the memory as a pre-read size during a period from an issue of the command to a completion of receiving the response for the storage device controller from the storage device corresponding to the command; and
storing the data being read from the buffer in order starting from a storage region of the memory that is shifted for the pre-read size after the response is completely received.

15. The method for controlling reading according to claim 14, wherein if the storage device controller outputs a transfer clock as a transfer synchronous clock to the storage device, and stops outputting the transfer clock when the buffer is full, the step c) includes reading the data from the buffer that is full and updating the pre-read size by adding a size of the data.

16. The method for controlling reading according to claim 15, wherein the step c) includes reading the data from the buffer and updating the pre-read size if the buffer is full, and a size of the data to be read from the storage device specified by the command is more than or equal to a data size that is storable in the buffer.

17. The method for controlling reading according to claim 16, wherein the step c) includes reading data from the buffer in a data size unit that is a storable in the buffer.
